(19) United States
(12) Patent Application Publication
(10) Pub. No.: US 2005/0252524 A1
(43) Pub. Date: Nov. 17, 2005

(54) PERMEABLE MEMBRANE CLEAN STATION

(75) Inventor: Paul A. Manfredi, Waterbury Center, VT (US)

Correspondence Address: FREDERICK W. GIBB, III;GIBB INTELLECTUAL PROPERTY LAW FIRM, LLC, 2568-A RIVA ROAD, SUITE 304, ANNAPOLIS, MD, 21401, US

(73) Assignee: INTERNATIONAL BUSINESS MACHINES CORPORATION, Armonk, NY (US)

(21) Appl. No.: 10/709,575

(22) Filed: May 14, 2004

(51) Int. Cl. B08B 7/00

(52) U.S. Cl. 134/2; 134/33; 134/147; 134/157; 134/149

(57) ABSTRACT

Disclosed in a cleaning apparatus (e.g., clean station) used during the production of semiconductor wafers. The clean station includes a holder for holding and rotating a semiconductor wafer, a shield surrounding the semiconductor wafer, and a dispenser positioned to dispense a cleaning fluid on the semiconductor wafer. The surface of the shield facing the semiconductor wafer comprises a semi-permeable material. The semi-permeable material prevents cleaning fluid ejected from the surface of the rotating semiconductor wafer from forming into a mist and being re-deposited back on the semiconductor wafer. The mist is harmful because it contains foreign material particles. The semi-permeable material comprises an absorptive material, a screen material, a perforated material, a finned material, etc. and is de-signed such that cleaning fluid ejected from the surface of the rotating semiconductor wafer is collected by and/or drains down the semi-permeable material. The semi-permeable material can be a permanent part of the shield or a disposable material designed to be periodically removed from the shield and replaced.

### BACKGROUND OF INVENTION

1. Field of the Invention

The present invention generally relates to a semiconductor manufacturing process and more particularly to an improved clean station that includes a shield that has a semi-permeable wall that prevents foreign matter from being re-deposited back on the cleaned substrate.

2. Description of the Related Art

After various stages in the semiconductor wafer manufacturing process, it is advantageous to clean the surface of the wafer (substrate) to prevent particles of foreign matter from contaminating subsequent processing steps. In order to clean a substrate, a clean station is provided that rotates the wafer while applying a cleaning fluid. Often, to prevent cleaning fluid from dispersing across a large area, a shield is placed to surround the rotating wafer/substrate.

However, it is common for a mist of cleaning fluid and foreign matter particles to accumulate within the shield. Often, this mist causes some of the foreign matter particles to be re-deposited upon the cleaned substrate/wafer. For example, one common problem experienced during semiconductor manufacturing processing occurs after chemical mechanical polishing of copper-based materials. Some of the foreign matter copper particles become redeposited even after the wafer is cleaned, which results in defects that are referred to as circular corrosion-type defects.

Conventional solutions to this problem have primarily concentrated upon improving the air flow within the shield so as to remove the undesirable mist. Also, some conventional solutions provide a uniquely shaped shield that tends to deflect the foreign matter particles away from the wafer/substrate.

Such conventional solutions are somewhat effective; however they add complexity and cost to the clean station. The invention described below provides a solution that avoids adding complexity or substantial cost the clean station, yet provides performance that exceeds conventional clean stations.

### SUMMARY OF INVENTION

The invention provides a cleaning apparatus (e.g., clean station) used during the production of semiconductor wafers. The clean station includes a holder for holding and rotating a semiconductor wafer, a shield surrounding the semiconductor wafer, and a dispenser positioned to dispense a cleaning fluid on the semiconductor wafer. The surface of the shield facing the semiconductor wafer comprises a semi-permeable material.

The semi-permeable material prevents cleaning fluid ejected from the surface of the rotating semiconductor wafer from forming into a mist and being re-deposited back on the semiconductor wafer. The mist is harmful because it contains foreign material particles. The semi-permeable material comprises an absorptive material, a screen material, a perforated material, a finned material, etc. and is designed such that cleaning fluid ejected from the surface of the rotating semiconductor wafer is collected by and/or drains down the semi-permeable material. The semi-permeable material can be a permanent part of the shield or a disposable material designed to be periodically removed from the shield and replaced.

To use the invention, the shield is positioned around the semiconductor wafer, which is rotated within the shield. Then, the cleaning fluid is applied to the surface of the substrate. Cleaning fluid ejected from the surface of the rotating semiconductor wafer is collected by and/or drains down the semi-permeable material and is prevented from forming into a mist and being re-deposited back on the semiconductor wafer. Thus, by lining the clean station shield with a semi-permeable membrane, the invention prevents unwanted circular corrosion caused by foreign matter particles being re-deposited back on the cleaned wafer.

### BRIEF DESCRIPTION OF DRAWINGS

The invention will be better understood from the following detailed description with reference to the drawings, in which:

FIG. 1 is a schematic diagram of a clean station;

FIG. 2 is a schematic diagram of a portion of the semi-permeable material along the inner portion of the shield;

FIG. 3 is a schematic diagram of a portion of the semi-permeable material along the inner portion of the shield; and

FIG. 4 is a flow diagram illustrating a preferred method of the invention.

### DETAILED DESCRIPTION

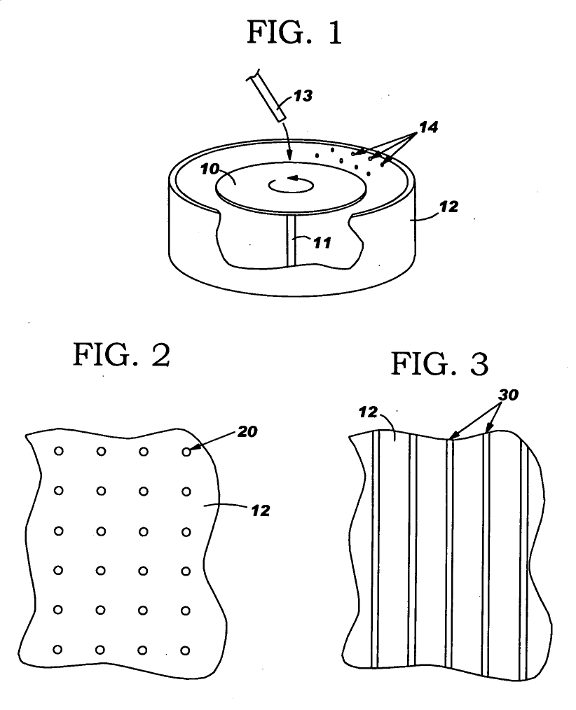

The invention provides a cleaning apparatus (e.g., clean station) used during the production of semiconductor wafers. As shown in FIG. 1, the clean station includes a holder 11 for holding and rotating a semiconductor wafer or substrate 10, a shield 12 surrounding the semiconductor wafer, and a dispenser 13 positioned to dispense a cleaning fluid on the semiconductor wafer. The surface of the shield 12 facing the semiconductor wafer comprises a semi-permeable material.

FIGS. 2 and 3 illustrate close-up schematic diagrams of portions of the shield 12 that face the interior of the clean station (face the semiconductor wafer or substrate 10). The semi-permeable material 12 comprises an absorptive material, a screen material, a perforated material, a finned material, etc. FIG. 2 illustrates perforations or screen openings 20. In addition, FIG. 2 is considered to illustrate an absorptive material such as any commercially available product that absorbs and holds vapors, particles, mist, etc. FIG. 3 illustrates ribs or fins 30 that similarly absorb and channel the mist and foreign matter particles. The fins 30 provide air flow/fluid flow control, and can be absorptive. The semi-permeable material prevents cleaning fluid and foreign matter particles 14 ejected from the surface of the rotating semiconductor wafer 10 from forming into a mist and being re-deposited back on the semiconductor wafer 10. Cleaning fluid 14 ejected from the surface of the rotating semiconductor wafer 10 is collected by and/or drains down the semi-permeable material 20, 30. The semi-permeable material 20, 30 can be a permanent part of the shield 12 or a disposable material designed to be periodically removed from the shield and replaced.

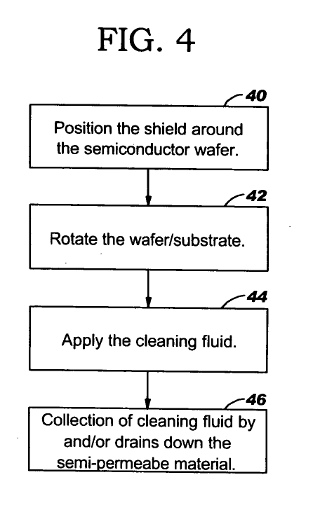

The flowchart in FIG. 4 illustrates the processing used with the invention. First, in item 40, the shield is positioned around the semiconductor wafer. Then, in item 42, the wafer/substrate is rotated within the shield. Then, in item 44, the cleaning fluid is applied to the surface of the substrate. Cleaning fluid ejected from the surface of the rotating semiconductor wafer is collected by and/or drains down the semi-permeable material (as indicated by item 46) is prevented from forming into a mist and being re-deposited back on the semiconductor wafer. Thus, by lining the clean station shield with a semi-permeable membrane, the invention prevents unwanted circular corrosion caused by foreign matter particles being redeposited back on the cleaned wafer. The permeable membrane substantially reduces the splashing, atomization of particles within the clean station by allowing absorption.

While the invention has been described in terms of preferred embodiments, those skilled in the art will recognize that the invention can be practiced with modification within the spirit and scope of the appended claims.

1. An apparatus comprising:
a holder adapted to hold and rotate a substrate;
a shield surrounding said substrate; and
a dispenser positioned to dispense a fluid on said substrate,
wherein a surface of said shield facing said substrate comprises a semi-permeable material.

2. The apparatus in claim 1, wherein said semi-permeable material prevents fluid ejected from the surface of the rotating substrate from forming into a mist and being re-deposited back on said substrate.

3. The apparatus in claim 2, wherein said mist comprises said fluid and foreign material particles.

4. The apparatus in claim 1, wherein said semi-permeable material comprises one of an absorptive material, a screen material, a perforated material and a finned material.

5. The apparatus in claim 1, wherein said semi-permeable material comprises a disposable material and is adapted to be periodically removed from said shield and replaced.

6. The apparatus in claim 1, wherein said semi-permeable material comprises a permanent part of said shield.

7. The apparatus in claim 1, wherein fluid ejected from the surface of the rotating substrate is collected by and drains down said semi-permeable material.

8. A cleaning apparatus used during the production of semiconductor wafers, said apparatus comprising:
a holder adapted to hold and rotate a semiconductor wafer;
a shield surrounding said semiconductor wafer; and
a dispenser positioned to dispense a cleaning fluid on said semiconductor wafer,
wherein a surface of said shield facing said semiconductor wafer comprises a semi-permeable material.

9. The apparatus in claim 8, wherein said semi-permeable material prevents cleaning fluid ejected from the surface of the rotating semiconductor wafer from forming into a mist and being re-deposited back on said semiconductor wafer.

10. The apparatus in claim 9, wherein said mist comprises said cleaning fluid and foreign material particles.

11. The apparatus in claim 8, wherein said semi-permeable material comprises one of an absorptive material, a screen material, a perforated material and a finned material.

12. The apparatus in claim 8, wherein said semi-permeable material comprises a disposable material and is adapted to be periodically removed from said shield and replaced.

13. The apparatus in claim 8, wherein said semi-permeable material comprises a permanent part of said shield.

14. The apparatus in claim 8, wherein cleaning fluid ejected from the surface of the rotating semiconductor wafer is collected by and drains down said semi-permeable material.

15. A method for cleaning a surface of a semiconductor wafer, said method comprising:
positioning a shield around said semiconductor wafer, wherein a surface of said shield facing said semiconductor wafer comprises a semi-permeable material;
rotating said semiconductor wafer within said shield; and
applying a cleaning fluid on a surface of the substrate.

16. The method in claim 15, wherein said semi-permeable material prevents cleaning fluid ejected from the surface of the rotating semiconductor wafer from forming into a mist and being redeposited back on said semiconductor wafer.

17. The method in claim 16, wherein said mist comprises said cleaning fluid and foreign material particles.

18. The method in claim 15, wherein said semi-permeable material comprises one of an absorptive material, a screen material, a perforated material and a finned material.

19. The method in claim 15, wherein cleaning fluid ejected from the surface of the rotating semiconductor wafer is collected by and drains down said semi-permeable material.

20. The method in claim 15, further comprising removing and replacing said semi-permeable material.
